(19) United States
(12) Patent Application Publication
(10) Pub. No.: US 2006/0041461 A1
(43) Pub. Date: Feb. 23, 2006

(54) Project management device and method

(76) Inventors: Mark Vucina, Pacific Grove, CA (US); Diana Vucina, Pacific Grove, CA (US)

Correspondence Address: Fountainhead Law Group, 900 Lafayette St., Ste. 509, Santa Clara, CA, 95050, US

(21) Appl. No.: 11/167,651

(22) Filed: Jun. 27, 2005

Related U.S. Application Data
(60) Provisional application No. 60/603,427, filed on Aug. 20, 2004.

(51) Int. Cl. G05B 19/418

(52) U.S. Cl. 705/8

(57) ABSTRACT

Embodiments of the present invention improve project management. In one embodiment the present invention includes a project management system comprising a plurality of task wedges arranged around a center. The task wedges may be keyed to tasks or vendors. In one embodiment, the project management system further comprises a plurality of concentric circles, wherein the difference in radii of adjacent circles represents an increment of time. In one embodiment, the project management system further comprises one or more task time bars to indicate tasks and their duration. In one embodiment, the project management system is implemented as a computer program. In one embodiment, the project management system is implemented as a printed chart.

### CROSS REFERENCE TO RELATED APPLICATIONS

This invention claims the benefit of priority from U.S. Provisional Application No. 60/603,427, filed Aug. 20, 2004, entitled “Project Management Device and Method.”

### BACKGROUND

The present invention is in the field of planning and time management and more specifically concerns a display and related method of arranging data that facilitates time and project management for any type of task or project.

People expend a tremendous amount of time and energy in attempting to organize and track various undertakings. This need to track and manage projects has resulted in an abundance of potential solutions. The simplest solution is merely a linear calendar perhaps as part of a proprietary personal planning booklet or diary. Simple calendars may be digitized and automated in the form of a personal digital assistant, which automatically issues reminders and may be synchronized through a computer system with calendars of many other individuals. At the complex end of the spectrum there exists many project planning computer software systems. These programs automatically calculate resources for various tasks and continually update the status of a project. For enhanced visual comprehension by the users such programs often display the projects as time lines, PERT charts or Gantt charts. These different display methods permit the project to be more readily visualized. However, they all suffer from the shortcoming of being essentially linear in form so that it is difficult or impossible to instantly appreciate the current status of a project—particularly a long or complex one.

Thus, there is a need for improved project management systems and methods.

Embodiments of the present invention improve project management. In one embodiment the present invention includes a project management system comprising a plurality of task wedges arranged around a center. In one embodiment, the center represents a point in time such as a target date, for example. The task wedges may be keyed to tasks or vendors. In one embodiment, the project management system further comprises a plurality of concentric circles, wherein the difference in radii of adjacent circles represents an increment of time. In one embodiment, the project management system further comprises one or more task time bars to indicate tasks and their duration. In one embodiment, the project management system is implemented as a computer program. In one embodiment, the project management system is implemented as a printed chart.

The following detailed description and accompanying drawings provide a better understanding of the nature and advantages of the present invention.

### BRIEF DESCRIPTION OF THE DRAWINGS

FIG. 1 is an example of a project management system according to another embodiment of the present invention.

FIG. 2 is an example of a project management system according to another embodiment of the present invention.

FIG. 3 is an example of a project management system according to another embodiment of the present invention.

FIG. 4 is an example of a project management system according to another embodiment of the present invention.

FIG. 5 is an example of a project management system according to another embodiment of the present invention.

FIG. 6A is an example of a task table of project management system according to another embodiment of the present invention.

FIG. 6B is an example of another table according to another embodiment of the present invention.

FIG. 7 is an example of a project management system according to another embodiment of the present invention.

FIG. 8 is an example of a project management system according to another embodiment of the present invention.

FIG. 9 is an example of a project management system according to another embodiment of the present invention.

FIG. 10 is an example of a project management system according to another embodiment of the present invention.

FIG. 11 is an example of a project management system implemented as a chart according to another embodiment of the present invention.

### DETAILED DESCRIPTION

Described herein are techniques for improving project management. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include obvious modifications and equivalents of the features and concepts described herein.

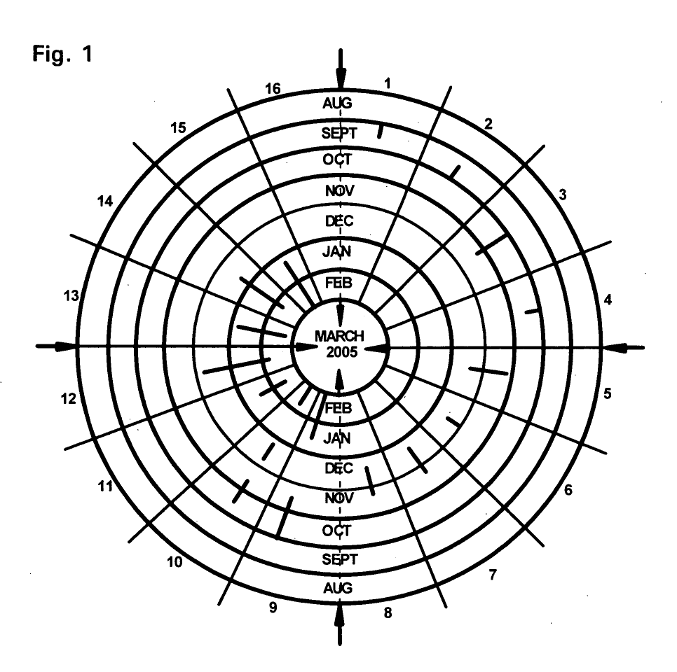

In its simplest form the present invention displays a schedule of tasks along with task responsible parties (vendors) and indication of critical tasks on a single easily comprehended page. The format is essentially a “bull's eye” target of concentric circles based on polar coordinates as opposed to the rectangular coordinates used for conventional time lines. This results in a display that is both easy to understand and simple to update. One implementation is shown in FIG. 1 where the display is arranged in an “inward” manner with the target date occupying the center of the bull's eye. Most individuals instinctively associate a target date with the center of a target so that this inward format is generally the most intuitive arrangement.

As shown in FIG. 1, with the “inward” format the target date is entered into the bull's eye. The circular display consists of a plurality of concentric circles each of which denotes a particular increment of time. In FIG. 1 each concentric circle represents the boundary between two months (that is, each circle marks the beginning of a month) and the difference in the radii of adjacent circles is a linear representation of one month. Similarly, the concentric circles could represent hours, days, weeks, years or any increment of time relevant to the project being displayed. In the inward display time moves forward (as indicated by arrows) towards the center of the display so that a larger circle is earlier in time than a smaller circle. In the “outward” display (see below) time moves forward from the center and the largest circle represents the targeted completion date.

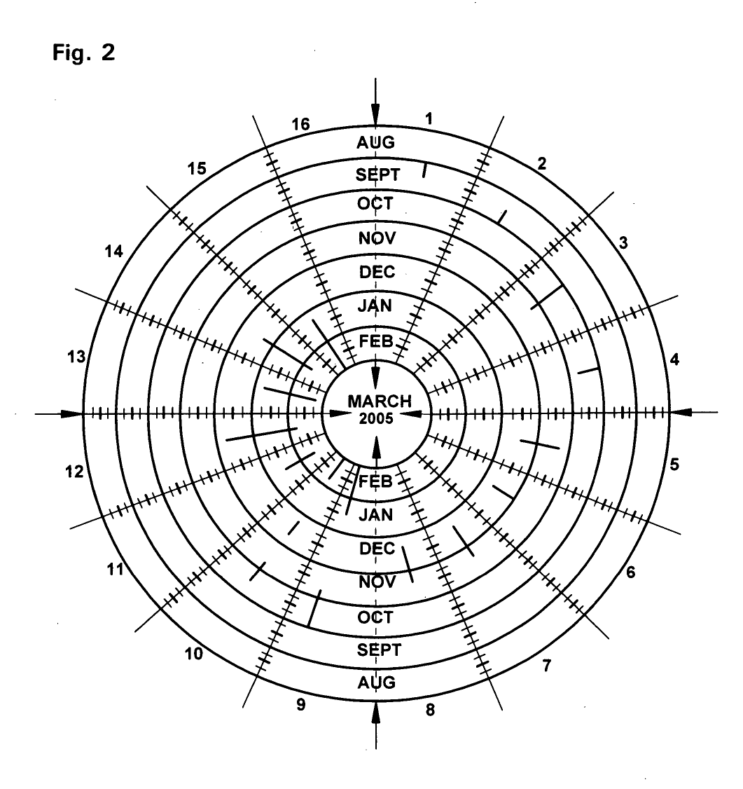

Since the radius segment between two adjacent concentric circles represents one month in the example, the radius segment can be subdivided by a series of tick marks (see FIG. 2) so that the distance between adjacent tick marks represents one week (that is, four weeks to the month). Because months do not necessarily precisely begin or end on the borders between calendar weeks, the symbolism of the display can be taken to represent the first, second, third and fourth week, etc. of a month.

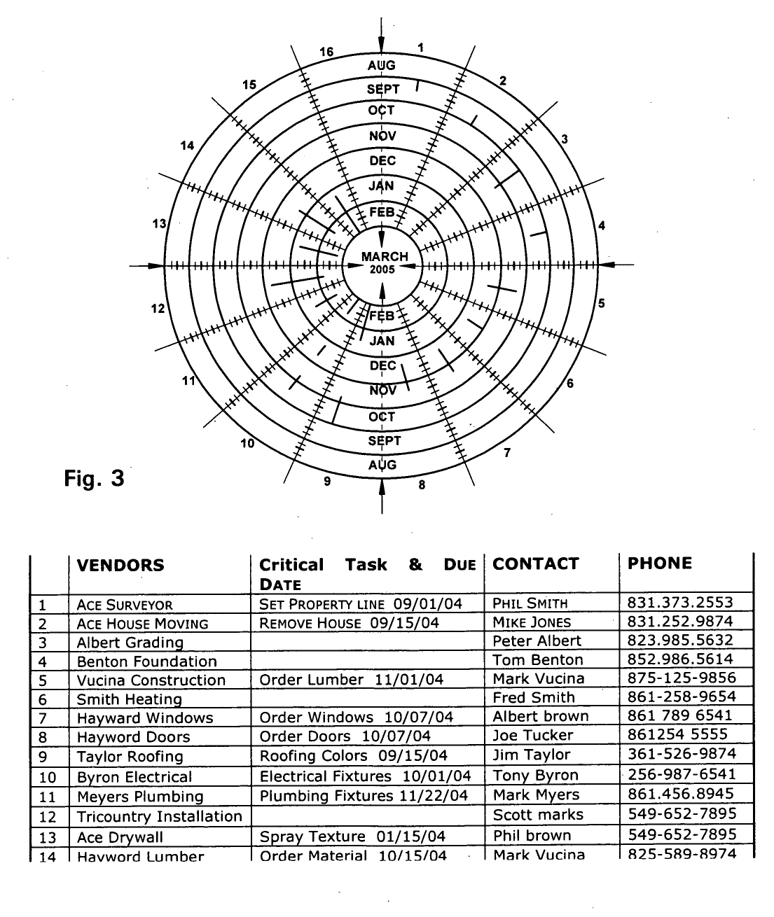

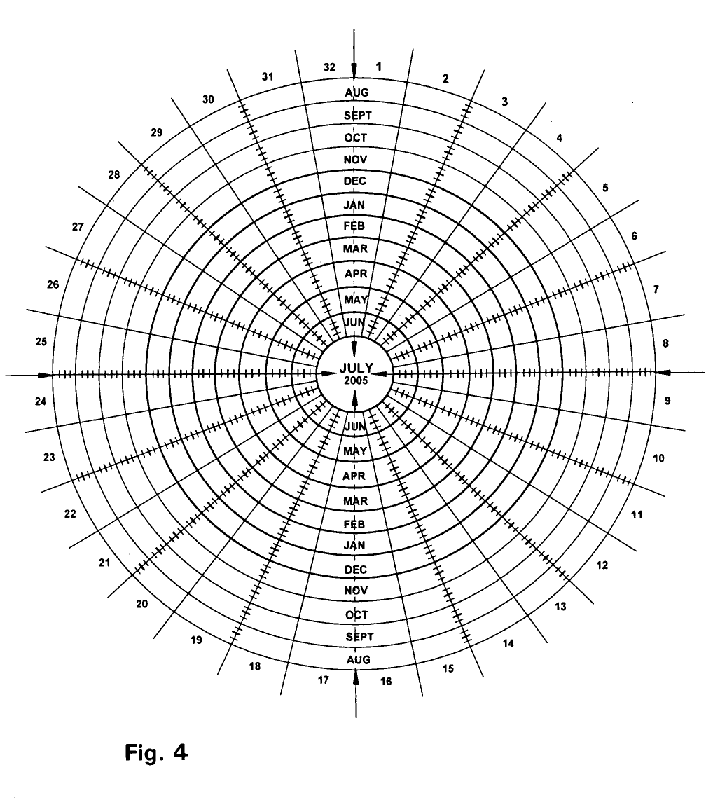

In any project there will be a number of discrete tasks that must be accomplished in some set order for the project to be completed successfully. Usually, there are one or more critical tasks upon which later tasks depend. Often one task is dependant upon the successful completion of an earlier task. In many cases task interdependency dictates a certain order to the tasks. A simplified example is given by the old saw that reminds one that the walls must be put up before the roof can be built. In many projects a given task or family of related tasks is carried out by a particular vendor. To facilitate representation of tasks/vendors the circular display is divided into a plurality of pie-shaped wedges or “slices” with each vendor (or family of related tasks) occupying one slice. FIG. 3 shows the target diagram of FIG. 2 with a related a table for listing the vendors and their critical tasks. Each vendor is keyed to a particular slice according to the slice number. The diagram can also assign a family of related tasks to each slice. The number of slices can be conveniently adjusted to fit a given project. FIG. 4 shows a display with 32 slices.

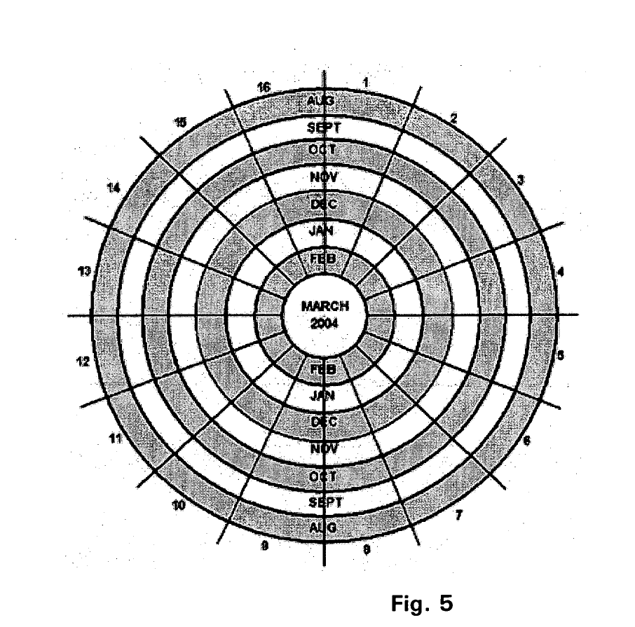

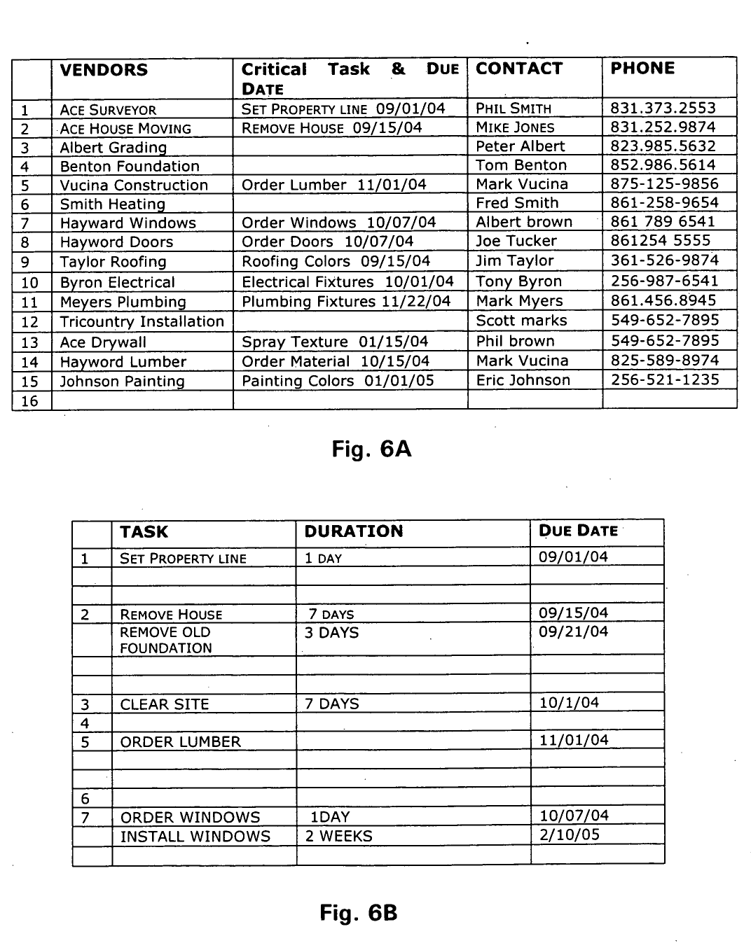

FIG. 6A shows the task table enlarged. A task can have a duration as well as a due date associated with it. Any one vendor is likely to have a number of temporally successive tasks that depend either on earlier tasks by that same vendor or on tasks carried out by other vendors. The table shown in FIG. 6B accommodates the subtasks as well as task durations. Note that the list of tasks and subtasks are keyed to the vendor (or to task family) according to number. When a project is initially planned, it is convenient to place radial bars in each slice to indicate the tasks and their duration (for example see FIG. 3). Although it is possible to position such time bars so that the due date falls at the end of the time bar, it may be more realistic to position the bar to extend a bit beyond the due date on the theory that most due dates tend to slip, especially in a large project. It is convenient, then, as the project progresses to mark the actual date of task completion with a symbol such as an asterisk. At any given time one can look around the concentric ring representing the current time to ensure that all tasks in the past actually show completion signs. Any task not showing such a symbol requires immediate attention. FIG. 5 shows a chart in which successive (concentric) time intervals are shaded with different colors to facilitate checking a given time period for task completion, etc.

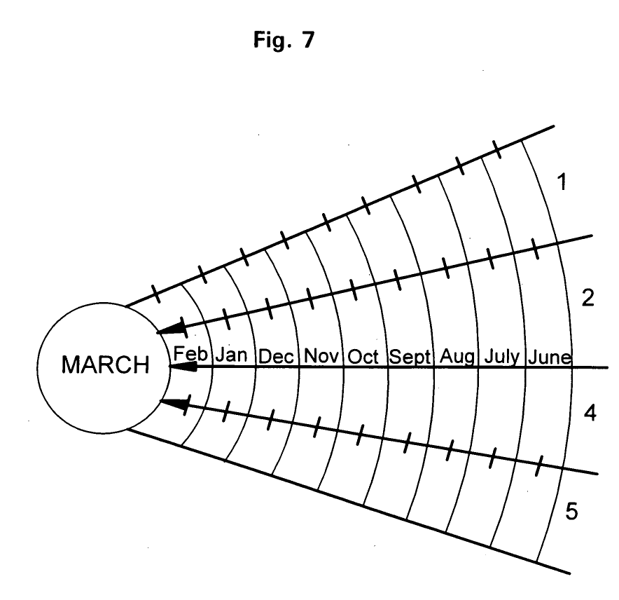

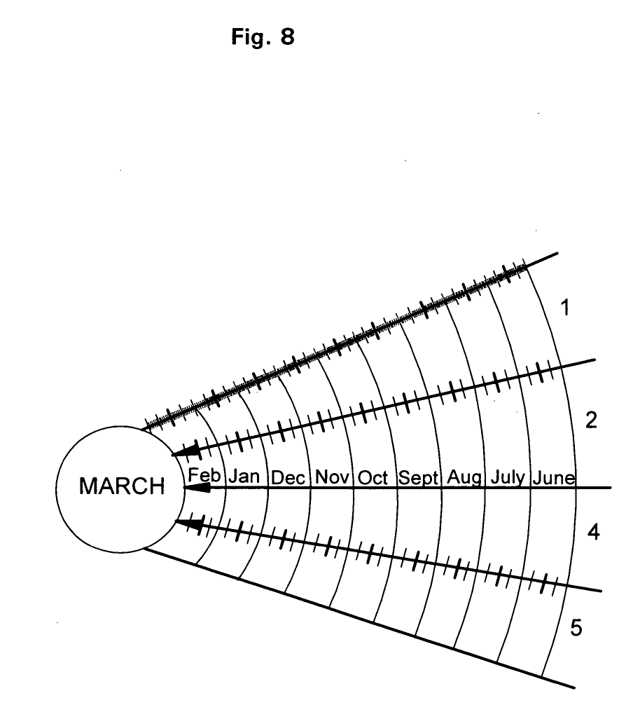

There are cases where a very large number of vendors or task families are involved, requiring an unwieldy number of separate wedges be cut from the display and/or cases where it is desired to view only a portion of the project at one time. For example, one may not wish to give all the project details to a particular vendor. These cases are accommodated by “partial slice” diagrams in which only one or a few slices are displayed. FIG. 7 shows such a display with a monthly time scale while FIG. 8 shows a similar display including weekly and even daily tick marks. Each of these charts shows only four of the vendor/task slices. It will be apparent that any number of slices can be displayed, and that the slices displayed are not necessarily contiguous (in terms of the full display).

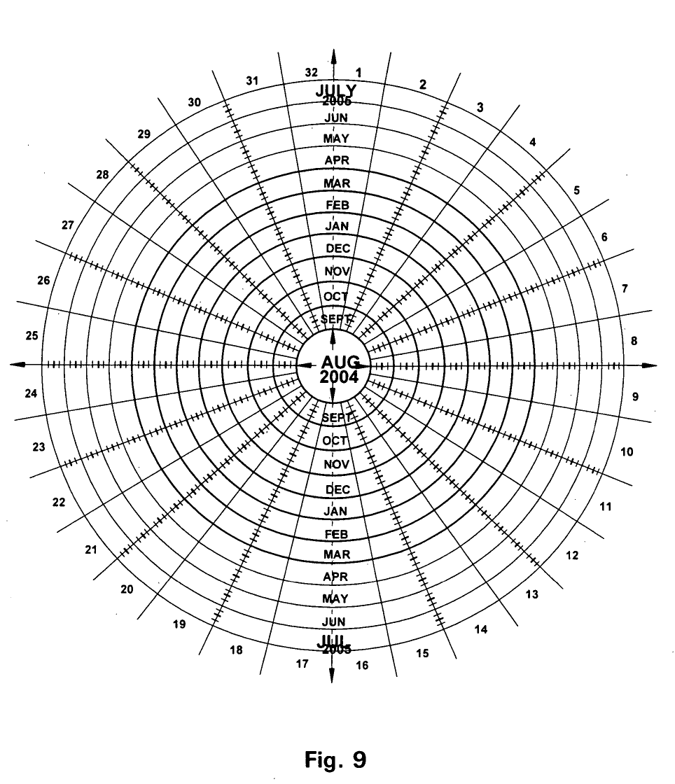

FIG. 9 shows an “outward” time version, which operates like the displays explained above except that the time flow is from the center to the outside. That is, the project starts at the center of the display and each larger concentric circle is successively later in time.

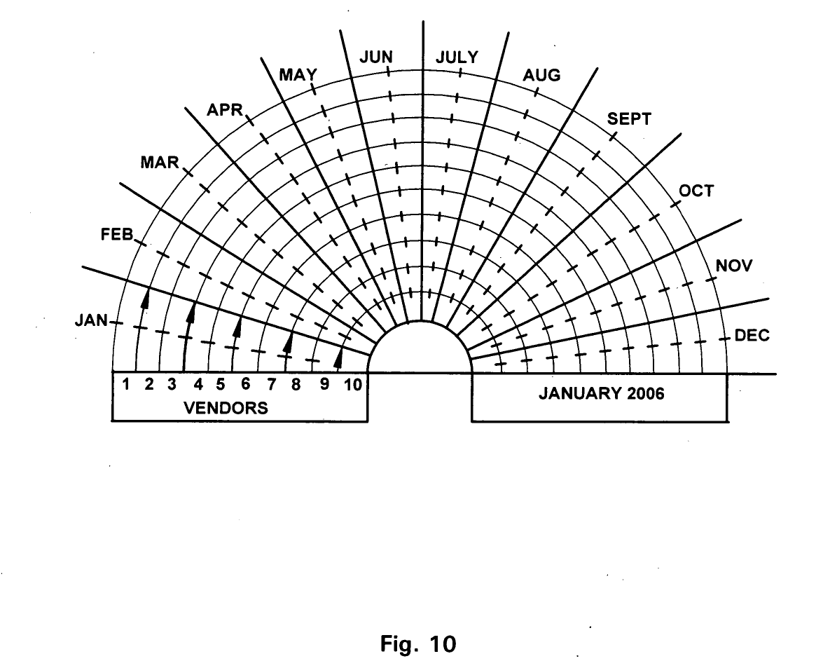

FIG. 10 shows yet another possible variation. This chart is a hybrid between the polar coordinate chart explained above and a more traditional timeline. Here time progresses from left to right so that each wedge is actually a time increment. The concentric pathways (1 to 10) are actually the individual vendor areas where task information is displayed.

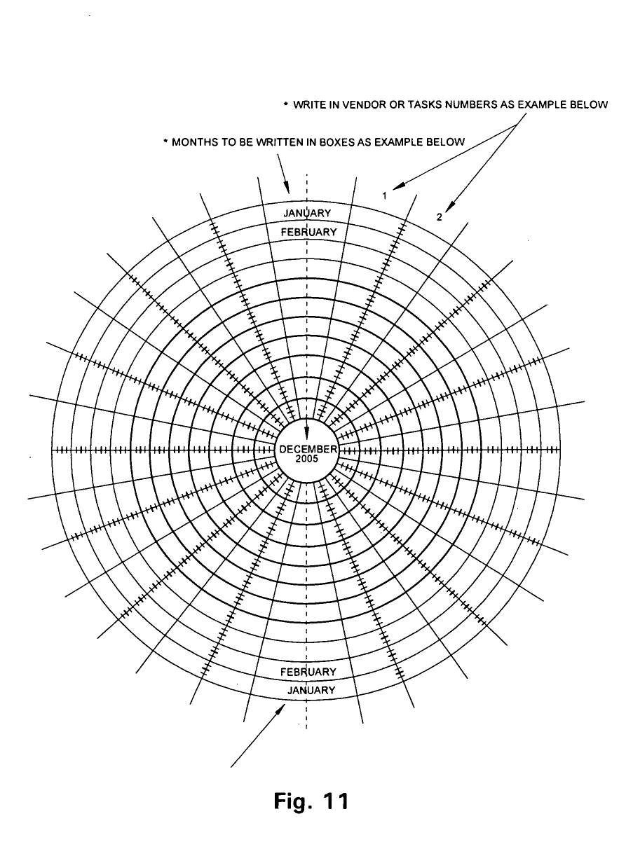

The invention can be implemented in a variety of manners. One simple version, illustrated as FIG. 11, is a preprinted “target” chart containing empty tables for vendor and task data. Such a chart can even be coated with a special surface for use with erasable markers. The user selects a target date and fills in the center with this date and inserts the appropriate time increments. This obviates the need to preprint a plurality of charts to cover all possible starting dates. The user fills in the task data and then enters the task time bars onto the display preferably in a contrasting color. Since the surface is erasable, it is simple to update the information as the project progresses and to make whatever corrections are necessary.

The charts can also be produced by a simple computer program. Again, the user enters time increment data, target date and vendor and task information. The system prints out the charts for distribution to project members. As the project progresses, the data are readily updated and new charts generated.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims. The terms and expressions that have been employed here are used to describe the various embodiments and examples. These terms and expressions are not to be construed as excluding equivalents of the features shown and described, or portions thereof, it being recognized that various modifications are possible within the scope of the appended claims.

What is claimed is:

1. A project management system comprising a plurality of radial timelines, wherein a plurality of task wedges are defined between adjacent radial timelines.

2. The system of claim 1 wherein the radial timelines are arranged around a center, and wherein the center represents a point in time.

3. The system of claim 1 further comprising associating each task wedge with information about one or more tasks or vendors.

4. The system of claim 1 wherein each radial timeline represents time advancing inward toward a center.

5. The system of claim 1 wherein each radial timeline represents time advancing outward away from a center.

6. The system of claim 1 further comprising a plurality of concentric circles, wherein the difference in radii of adjacent circles represents an increment of time.

7. The system of claim 6 wherein the increment of time user definable.

8. The system of claim 1 further comprising one or more task time bars for indicating the duration of a task.

9. The system of claim 1 wherein said project management system is implemented as a computer program.

10. The system of claim 1 wherein said project management system is implemented as a printed chart.

11. A project management system comprising:
a plurality of task wedges displayed around a center; and
a plurality of concentric circles displayed around the center, wherein the difference in radii of adjacent circles represents an increment of time.

12. The system of claim 11 wherein each task wedge is associated with information about one or more tasks or vendors.

13. The system of claim 11 wherein the increment of time is user definable.

14. The system of claim 11 further comprising one or more task time bars for indicating the duration of a task, wherein at least one task wedge includes one or more task time bars.

15. The system of claim 11 wherein said project management system is implemented as a computer program.

16. The system of claim 11 wherein said project management system is implemented as a printed chart.

17. A project management method comprising displaying a plurality of radial timelines around a center, wherein a plurality of task wedges defined between adjacent timelines correspond to one or more tasks.

18. The method of claim 17 further comprising displaying a plurality of concentric circles around the center, wherein the difference in radii of adjacent circles represents an increment of time.

19. The method of claim 17 further comprising displaying one or more. task time bars for indicating the duration of a task, wherein at least one task wedge includes one or more task time bars.

20. The method of claim 17 further comprising associating each task wedge with information about one or more tasks or vendors.
